(19) United States
(12) Patent Application Publication
(10) Pub. No.: US 2003/0041023 A1
(43) Pub. Date: Feb. 27, 2003

(54) Product-directed electronic commerce system

(76) Inventors: Tim Goldstein, Loveland, CO (US); Roger A. Jollis, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 09/935,967

(22) Filed: Aug. 23, 2001

(51) Int. Cl. G06F 17/60

(52) U.S. Cl. 705/39; 705/26

(57) ABSTRACT

A method, apparatus, and data structure for facilitating electronic commerce using a product having a unique identifier. The method involves providing an account number that is associated with the unique product identifier for enabling a commercial transaction. The apparatus comprises a product having a unique identifier, and a computing unit for providing an account number that is associated with the product identifier for enabling a commercial transaction. Also disclosed is a data file embodied in a computer-readable medium comprising an identifier segment comprising information corresponding to a representation of a product identifier, and an account number segment comprising information corresponding to a representation of an account number for enabling a commercial transaction.

### TECHNICAL FIELD

The subject matter disclosed here generally relates to data processing and, more particularly, to facilitate electronic commerce using a product having a unique identifier.

### BACKGROUND

U.S. Pat. No. 5,883,810, and WIPO Publication Nos. WO 00/75749 and 00/75843 are incorporated by reference here. These publications generally describe systems for facilitating electronic commerce without providing a consumer's credit card data over the Internet.

For example, as reproduced here in FIG. 1, U.S. Pat. No. 5,833,810 (“the '810 patent”) discloses a system 20 for conducting online commerce transactions. For general discussion purposes, three participants to an online commerce transaction are shown in FIG. 1: a customer 22, a merchant 24, and an issuing bank 26. These three participants play the primary roles in the online commerce transaction. The customer and merchant may represent individual people, entities, or businesses. Although labeled as a “bank,” the issuing bank 26 may represent other types of card-issuing institutions, such as credit card companies, card-sponsoring companies, or third party issuers under contract with financial institutions. It is further noted that other participants may be involved in some phases of the transaction, such as an intermediary settlement institution, but these participants are not shown.

Each participant is equipped with a computing system to facilitate online commerce transactions. The customer 22 has a computing unit 28 in the form of a personal computer, although other types of computing units may be used including laptops, notebooks, handheld computers, set-top boxes, and the like. The merchant 24 has a computing unit 30 implemented in the form of a computer server, although other implementations are possible. The bank 26 has a computing center 32 shown as a mainframe computer. However, the bank-computing center 32 may be implemented in other forms, such as a minicomputer, a PC, a server, a networked set of computers, and the like.

The computing units 28, 30, and 32 are connected with each other via a data communication network 34. The network 34 is a public network and assumed to be insecure and open to eavesdroppers. In the illustrated implementation, the network is embodied as the Internet. In this context, the computers may or may not be connected to the Internet 34 at all times. For instance, the customer computer 28 may employ a modem to occasionally connect to the Internet 34, whereas the bank-computing center 32 might maintain a permanent connection to the Internet 34. It is noted that the network 34 may be implemented as other types of networks, such as an interactive television (ITV) network.

The merchant computer 30 and the bank computer 32 are interconnected via a second network, referred to as a “payment network” 36. The payment network 36 represents existing proprietary networks that presently accommodate transactions for credit cards, debit cards, and other types of financial/banking cards. The payment network 36 is a closed network that is assumed to be secure from eavesdroppers. Examples of the payment network 36 include the VisaNet® network and the Veriphone® network.

The electronic commerce system 20 is implemented as computer software modules loaded onto the customer computer 28 and the bank-computing center 32. The merchant computer 30 does not require any additional software to participate in the online commerce transaction supported by the online commerce system 20.

There are three distinct phases supported by the online commerce system 20: a registration phase, a transaction phase, and a payment authorization phase. During the registration phase, the customer 22 requests an online commerce card from the issuing bank 26. The issuing bank 26 creates an online commerce card for the customer and assigns a permanent customer account number to the card. The permanent customer account number is retained in a data record at the issuing bank 26 and is not given to the customer 22. This prevents the customer account number from being stolen while being transferred over the Internet 34 or stored on the customer's computer 28.

The “online commerce card” does not exist in physical form, but in digital form for use in online transactions. The issuing bank 26 issues the card to the customer 22 in the form of a signed digital certificate binding the customer to the bank and a software module that can be invoked when using the commerce card to conduct a transaction on the Internet 34. The commerce card is configured to be used by the customer in one or more areas of commerce in which the customer typically employs a credit card, a debit card, a bankcard, or other type of financial services card.

During the transaction phase, the customer 22 invokes the software module, which submits a request for a secure card number to the issuing bank 26. The issuing bank generates a random temporary transaction number and associates the transaction number with the permanent customer account number in a data record. The issuing bank 26 issues the transaction number to the customer to use as a proxy for the real customer account number. The transaction number resembles a real account number. In the case of a credit card, for example, the transaction number and real customer account number are both 16-digit, mod 10, numbers identically formatted with four spaced sets of 4-digits. To the customer (and every other participant in the transaction), the transaction number appears to be a valid credit card number. Only the issuing bank 26 differentiates the transaction numbers from the real customer account numbers. The customer 22 uses the proxy transaction number in the transaction with the merchant 24. Because the transaction number is issued in place of the customer number for only a single transaction and with a limited life, a thief that intercepts the transaction number is prevented from using it for illicit gain.

During the payment authorization phase, the merchant 24 submits the transaction number over the conventional payment network 36 to the issuing bank 26 for approval. The issuing bank 26 identifies the number as a transaction number, as opposed to a real customer account number. The issuing bank 26 uses the transaction number to retrieve the data record linking the transaction number to a customer account number. The issuing bank 26 then swaps the customer account number for the transaction number and processes the authorization request using its conventional processing system. After the processing, the issuing bank 26 substitutes the transaction number back for the customer account number and returns the authorization reply to the merchant 24 under the transaction number. In this manner, only the issuing bank is aware that the transaction number is a proxy for the customer account number. The merchant 24 need not be aware that the transaction number is not a true customer account number, but simply handles the number as it would any other card number.

Such conventional approaches suffer from a variety of drawbacks. For example, the customer 22 must have access to, and be able to operate, a computer 28 for requesting the temporary transaction number. Furthermore, although the merchant computer 30 does not require any additional software, the merchant 24 does not have any control over which banks 26 will issue the online commerce card or at which establishments that card will be used. Consequently, there may be limited incentive to participate in the conventional system.

### SUMMARY

These and other drawbacks of conventional approaches are addressed here by providing a method for facilitating electronic commerce using a product comprising the step of providing an account number that is associated with a unique product identifier for enabling a commercial transaction. An apparatus for facilitating electronic commerce comprises a product having a unique identifier, and a computing unit for providing an account number that is associated with the product identifier for enabling a commercial transaction. Also disclosed is a data file embodied in a computer-readable medium comprising all identifier segment comprising information corresponding to a representation of a product identifier, and an account number segment comprising information corresponding to a representation of an account number for enabling a commercial transaction.

### BRIEF DESCRIPTION OF THE DRAWINGS

Various aspects of the invention will now be described with reference to the following figures (“FIGS. ”) which are not necessarily drawn to scale, but use the same reference numerals to designate corresponding parts throughout each of the several drawings.

FIG. 1 is a diagrammatic illustration of a conventional online commerce system.

FIG. 2 is a diagrammatic illustration of an embodiment of a product-directed online commerce system according to the present invention.

FIG. 3 is a diagrammatic illustration of another product-directed online commerce system according to the present invention.

FIG. 4 is a flow diagram for an exemplary registration process according to the present invention.

FIG. 5 is a flow diagram for an exemplary transaction process according to the present invention.

FIG. 6 is a diagrammatic illustration of yet another product-directed online commerce system.

### DETAILED DESCRIPTION OF THE PREFERRED EMBODIMENTS

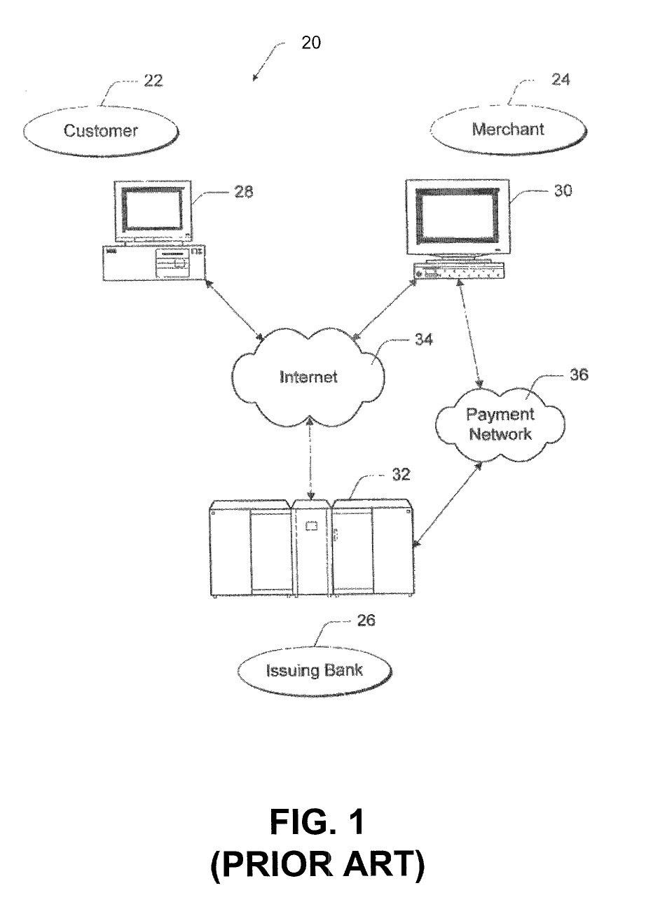

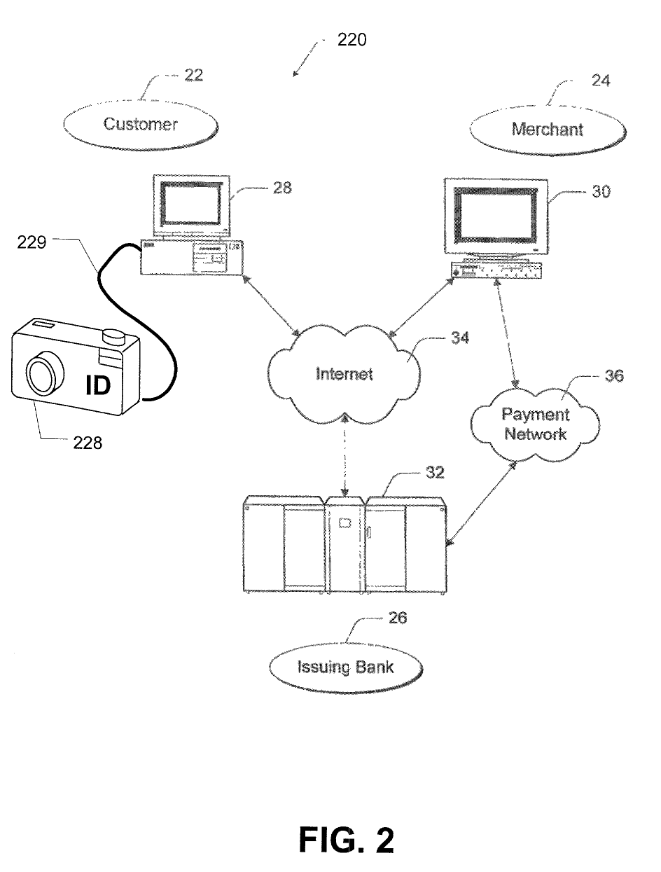

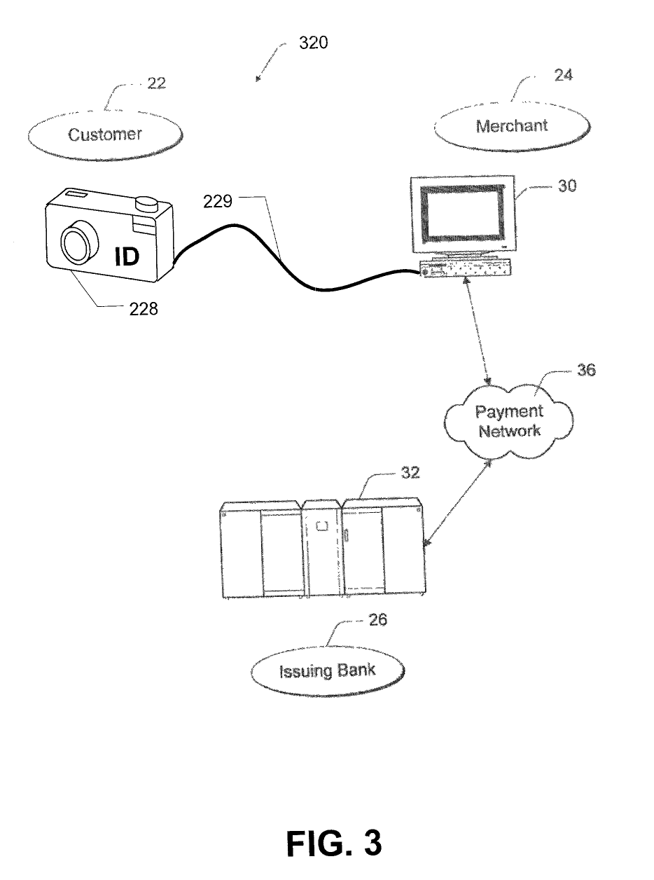

FIG. 2 is a diagrammatic illustration of one architecture for implementing a product-directed electronic commerce system 220, according to the present invention, the participants described above with respect to FIG. 1. In addition, FIG. 2 illustrates a customer product 228 that is connectable to the customer computing unit 28. FIG. 3 illustrates another architecture for implementing a product-oriented commerce system 320 where the product 228 is communicatively connected to the merchant computing unit 30, including, but not limited to wired and/or wireless connections. Although only a single bank 26, supporting one merchant 24, with a single customer 22, having one product 228 connected to computing units 28 or 30, are illustrated in FIGS. 2 and 3, these systems may also be configured for multiple customers, products, merchants, and/or issuing banks.

For the examples discussed below, the customer product 228 is typically used by the customer 22 who will have purchased, leased, borrowed, or otherwise obtained the product from the merchant 24, or another source (not shown). Consequently, the customer 22 is also referred to here as a “consumer” while the product 228 is also referred to as a “consumer product.” In the same manner, the merchant 24 is also referred to as the supplier of the consumer product 228, or simply the “supplier.” As a product supplier, the merchant 24 may be any entity that is involved in the distribution of the consumer product 228, including without limitation, a manufacturer, licensor, wholesaler, retailer, reseller, and/or service provider. The merchant 24 may also be a related or unrelated entity that operates the merchant computing unit 30 in order to provide products and/or services in connection with the product 228 as described below.

The consumer product 228 is preferably an electronic consumer product, such as a digital camera, media recorder, media player, personal digital assistant, or other device that is communicatively connectable to the customer computing unit 28 and/or merchant computing unit 30 by an interface 229. Although a cable interface 229 is illustrated in FIG. 2, a variety of other interfaces may be provided between the product 228 and the customer computing unit 28, including wireless and/or manual interfaces.

Alternatively, just a portion of the product 229 (such as a removable memory component) may be interfaced with the computing unit 28.

The interface 229 allows data to be communicated between the product 228 and the customer computer 30. For example, the interface 229 may transfer data automatically and wirelessly transfer from the product 228 to the customer computing unit 28 when the product is near the unit. The interface 229 may also be arranged to carry data over longer distances using the Internet or other communications networks, such as a mobile telephone network.

The data referred to above preferably comprises a product identifier that is illustrated by the abbreviation “ID” in FIGS. 2 and 3. The identifier serves to uniquely identify the product 228 among all of the products that may properly communicate with the customer computer unit 28 (FIG. 2) and/or the merchant computer 30 (FIG. 3). Consequently, each of the products 228 will have its own distinctive identifier. A wide variety of identifiers may be used including numeric, alphabetic, textual, contextual, and pictorial identifiers in various mechanical, electrical, and/or electronic formats.

For example, the identifier may correspond to the serial number of the product 228 and be stored in read only memory (“ROM”) inside the product. Alternatively, or in addition, such a serial number identifier may be in a human- and/or machine-readable from the exterior of the camera, such as in an encrypted barcode format. In yet another configuration, the identifier for a particular product 228 may be a code that is entered manually into the computing units 28 and/or 30 by the corresponding customer 22 and/or merchant 30. In yet another configuration, the identifier for a particular product 228 may be a code that is entered manually into the computing units 28 and/or 30 by the corresponding customer 22 and/or merchant. This identifier may be entered either physically through a removable media or through a keypad or through voice inputs. In still another configuration, the code may be in the form of a sound file, such as a voice sample of the owner of the product. Such a voice sample could also be useful in verifying ownership of the product before a transaction is initiated with the product. Multiple voice samples of different voices could also be used.

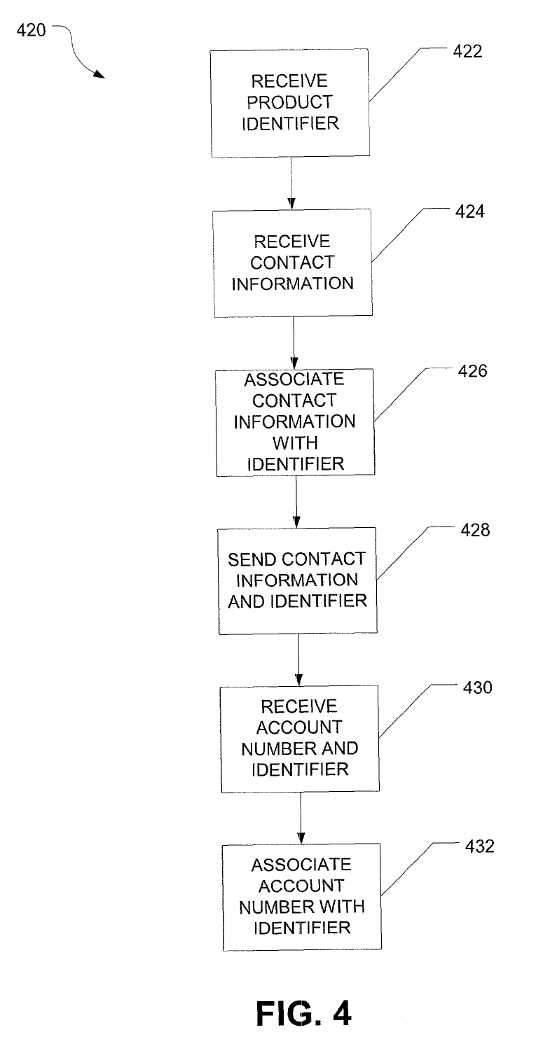

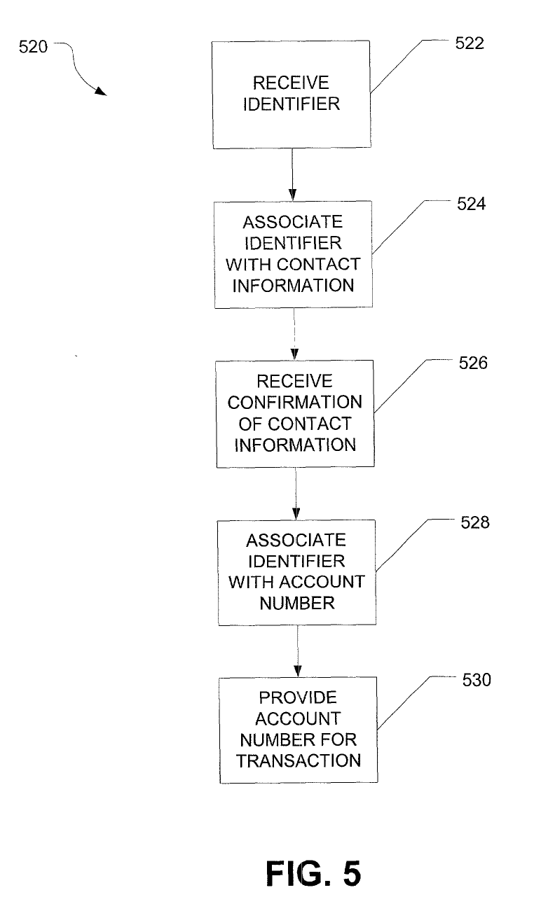

The structure, function, and operation of product-directed commerce systems according to the present invention such as systems 220 and 320 shown in FIGS. 2 and 3 will now be described with respect to the flow diagrams shown in FIGS. 4 and 5. FIG. 4 illustrates one embodiment of a registration process 420, according to the present invention, during which information about the customer 22 is associated with the unique product identifier. FIG. 5 illustrates one embodiment of a subsequent transaction process during which the product identifier is associated with a customer account number.

The associations described here may be made using a variety of data structures and processing techniques. However, the data structure is preferably an electronic data structure contained in a computer readable medium for use by, or in connection with, the computing units 28, 30, 32 and/or other computing systems that they may communicate with. In the context of this document, a “computer readable medium” comprises any electronic, magnetic, optical, or other physical device or means that can contain or store a computer program for use by, or in connection with, a computer-related system or method, such as the computing units 28, 30, and 32. However, the computer-related system may be any instruction execution system, apparatus, or device, such as a computer-based system, processor-containing system, or other system that can fetch the instructions from the instruction execution system, apparatus, or device and then execute those instructions. Therefore, in the context of this document, a computer-readable medium can be any means that will store, communicate, propagate, or transport the program for use by, or in connection with, the instruction execution system, apparatus, or device.

For example, the computer readable medium may take a variety of forms including, but is not limited to, an electronic, magnetic, optical, electromagnetic, infrared, or semiconductor system, apparatus, device, or propagation medium. More specific examples of a computer-readable medium include without limitation an electrical connection (electronic) having one or more wires, a portable computer diskette (magnetic), a random access memory (“RAM”) (electronic), a read-only memory (“ROM”) (electronic), an erasable programmable read-only memory (“EPROM,” “EEPROM,” or Flash memory) (electronic), an optical fiber (optical), and a portable compact disc read-only memory (“CDROM”) (optical). The computer readable medium could even be paper or another suitable medium upon which the program is printed, as the program can be electronically captured, for instance via optical sensing or scanning of the paper, and then compiled, interpreted or otherwise processed in a suitable manner.

Each block in FIGS. 4 and 5 represents an activity, step, module, segment, or portion of computer code that will typically comprise one or more executable instructions for implementing the specific logical function(s). It should also be noted that, in various alternative implementations, the functions noted in the blocks will occur out of the order noted in the figures. For example, multiple functions in different blocks may be executed substantially concurrently, in a different order, incompletely, and/or over an extended period of time, depending on the functionality involved. Various steps may also be manually completed.

Turning now to FIG. 4, the registration process will typically take place around the time that the customer 22 obtains the product 228 from the merchant 24, or other supplier although it may occur later. In a preferred embodiment, the product 228 will be provided with software that can be stored and executed on the customer computing unit 28 in order to facilitate the registration process 420 using the configuration shown in FIG. 2. Alternatively, or in addition, the merchant computing 30 unit may be provided with similar software for use by customers 22 and/or merchants 24 in the configuration shown in FIG. 3. The registration software (not shown) may be delivered in a variety formats, including being stored in memory inside the product 228.

Following instructions contained in the registration software (not shown), the computing units 28 or 30 will receive the identifier from the product 228 at step 422. Alternatively, the customer 22 or merchant 24 may simply enter the identifier into the computing unit 28 or 30 manually, without using the interface 229. Once the identifier is received by the computing unit 28 or 30, the customer or merchant respectively, will be prompted to provide contact information, including, but not limited to, the name, address, telephone number, and social security number of the customer, and an optional personal identification number. This contact information is received by the connected computing unit 28 or 30 at step 424. Billing information such as a billing address, bank routing and account numbers, and/or credit or debit card account numbers may also be provided with the contact information, or in a separate, more-secure communication, such as a voice or postal communication.

If entered into the customer computing unit 28, the contact information and product identifier (and any billing information) are then transmitted over the Internet 34 to the merchant computing unit 30. Alternatively, or in addition, the contact information and identifier may be sent directly to the bank computing unit 32.

Once the contact information and identifier have been received by the merchant computing unit 30, they are associated with each other, preferably in a data structure that is maintained by the merchant 24 at step 426. For example, the data structure may be a database, such as a data file embodied in a computer-readable medium. The data file will have an identifier segment comprising information corresponding to a digital representation of a product identifier, and an account number segment comprising information corresponding to a digital representation of an account number for enabling a commercial transaction. More specifically, this information may be stored as different fields of a customer record that is part of a database contained in the memory of the merchant computing unit 30. Of course, various other data structures may also be used, comprising manual data structures.

The merchant computer 30 will then send the contact information for the customer 22 along with the identifier to the issuing bank computing unit 32 at step 428. The transmission of this information may occur over the Internet 34 or a payment network 36. Alternatively, for increased security, a proxy of the identifier may be provided to the issuing bank computing unit 32. The issuing bank 26 will perform a credit check based upon the contact information and, if the customer 22 is creditworthy, create a customer account number for use in commercial transactions, such as credit transactions. For example, the account number may be a credit or debit card number, a deposit or line of credit account number, or an open letter of credit that the customer can use to purchase goods and services.

The issuing bank computing unit 32 then sends the customer account number with the product identifier (or the proxy) over the Internet 34 (or payment network 36) where it is received by the merchant computing unit 30 and/or the customer computing unit 28 at step 430. At step 432, the merchant computing unit 30 associates the customer account number (or proxy) with the customer information already in the database and the registration phase is complete. For security purposes the customer account number may be segregated from the other information and/or stored in a separate facility. The issuing bank computing unit 32 may also associate the customer account number (or proxy), product identifier, and/or contact information.

Turning now to the transaction process 520 illustrated in FIG. 5, a customer 22 desiring to make a purchase using the customer account number first connects the product 228 to the customer computing unit 28 (as in FIG. 2) or the merchant computing unit 24 (as in FIG. 3). For example, and not by way of limitation, the merchant computing unit 24 that is shown in FIG. 3 may be part of a retail, self-service kiosk, or network of such kiosks. Each kiosk in the network may be operated by a different merchant with one merchant managing a database. At step 522, the merchant computing unit 30 receives the product identifier, either directly from the product 228 (FIG. 3), or via the customer computing unit 28 (FIG. 2).

Steps 524 and 526 are optional security enhancements. At optional step 524, the merchant computer associates the identifier with the contact information. For example, the merchant computer 30 will perform a lookup of its own database or request a lookup from the manager of the database. At the next optional step 526, the customer 22 may be asked to confirm the contact information, such as by providing a Personal Identification Number (“PIN”) or contact name that can be verified against data already available in the merchant computer 30.

If the confirmation is successful, then the merchant 24 will associate the identifier with the customer account number at step 528. For example, the association may require a database lookup. At step 530, the merchant 24 will then provide the transaction number to the customer 22, issuing bank 32, or another merchant for completing any transactions that are requested by the customer 22. If the transaction is being executed at the customer computing unit 28, then a temporary transaction number may be provided by the merchant 24 or bank 26 for transfer over the Internet 34 as described with respect to the conventional system shown in FIG. 1.

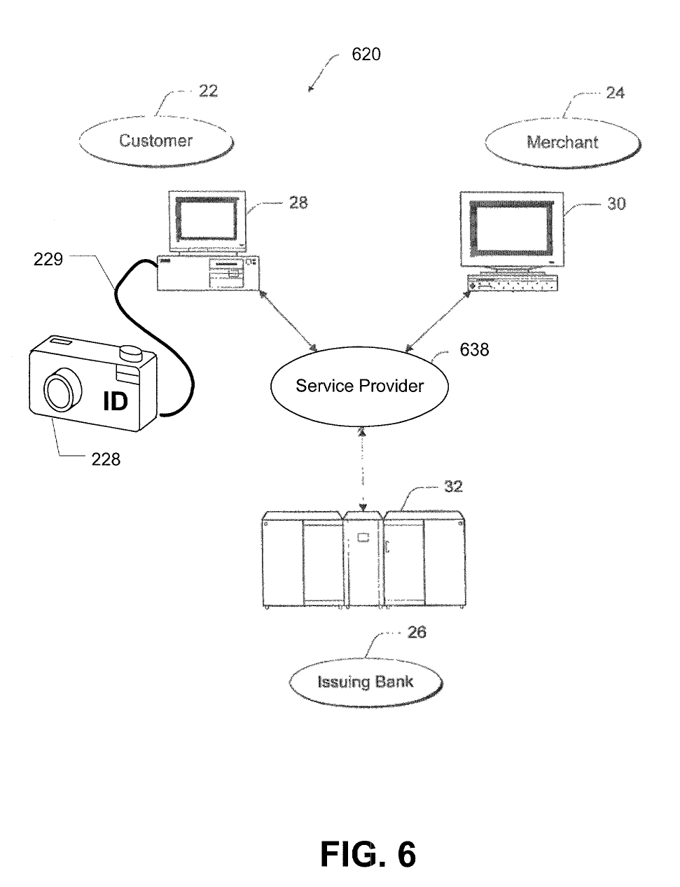

FIG. 6 is a diagrammatic illustration of yet another embodiment of a product-directed online commerce system. In FIG. 6, the communications between each of the participants are routed through a centralized service provider 638. The service provider 638 is preferably also the supplier of the product 228. The communications may be sent over the Internet or on a proprietary network operated by the supplier of the product 228.

The systems described above enable consumers to make credit transactions without having to provide an account number to a merchant 24 for each transaction. Consequently, these transaction are more convenient and secure for the customer 22.

These systems are also “product-directed” in that they can be made available to any product that can be provided with an appropriate identifier. Similarly, access may be limited to products coming from just a certain supplier. New products and/or suppliers can be added to the systems by simply designating a new series of identifiers. Consequently, systems implemented according to the present invention are quite flexible.

Finally, systems implemented according to the present invention are also “merchant-directed” in that only those merchants who have access to the customer account number associated with a particular identifier will be able to complete product-directed transactions. Moreover, those merchants will be able to direct customer credit applications and payments to certain issuing banks that will also have an incentive to participate. Consequently, there is an incentive for merchants to participate in the systems implemented according to the present invention.

1. A method for facilitating electronic commerce using a product, comprising the step of providing an account number that is associated with a unique identifier of the product for enabling a commercial transaction.

2 The method recited in claim 1 wherein said account number is provided in response to a request comprising the product identifier.

3. The method recited in claim 1, wherein said account number is provided by a merchant.

4 The method recited in claim 1, wherein said account number is provided by an issuing bank.

5. The method recited in claim 1 further comprising the step of associating contact information with the product identifier.

6. An apparatus for facilitating electronic commerce, comprising:
a product having an identifier; and
a computing unit for providing an account number that is associated with the product identifier for enabling a commercial transaction.

7. The apparatus recited in claim 6, wherein said computing unit further comprises a merchant computing unit.

8. The apparatus recited in claim 6, wherein said computing unit further comprises an issuing bank computing unit.

9. The apparatus recited in claim 6, further comprising another computing unit for associating contact information with the identifier.

10. A data file embodied in a computer-readable medium, comprising:
an identifier segment comprising information corresponding to a representation of a product identifier; and
an account number segment comprising information corresponding to a representation of an account number for enabling a commercial transaction.

11. The data file recited in claim 10 wherein the computer-readable medium resides in a merchant computing unit.

12. The data file recited in claim 10, wherein the computer-readable medium resides in an issuing bank computing unit.

13. The data file recited in claim 10, further comprising a contact segment comprising information corresponding to digital representation of contact information for the account number.
